(19) United States
(12) Patent Application Publication
(10) Pub. No.: US 2022/0342087 A1
(43) Pub. Date: Oct. 27, 2022

(54) METHOD FOR PROCESSING GPS POSITION SIGNALS IN A VEHICLE

(71) Applicant: ZF Friedrichshafen AG, Friedrichshafen (DE)

(72) Inventors: Rachid Mansour, Markdorf (DE); Robert Gronner, Friedrichshafen (DE); Thomas Ascher, Amtzell (DE); Freddy Josef Frombach, Eriskirch (DE); Maik Würthner, Markdorf (DE)

(73) Assignee: ZF Friedrichshafen AG, Friedrichshafen (DE)

(21) Appl. No.: 17/763,882

(22) PCT Filed: Oct. 6, 2020
(86) PCT No.: PCT/EP2020/077927

§ 371 Date: Mar. 25, 2022

(30) Foreign Application Priority Data
Oct. 18, 2019 (DE) 10 2019 216 104.9

(51) Int. Cl. G01S 19/52

(52) U.S. Cl. CPC G01S 19/52; B60W 40/105

(57) ABSTRACT

A method for processing GPS position signals in a vehicle is proposed, wherein the GPS position signals of the vehicle are received successively at a predefined time interval and are processed in order to control the vehicle, and wherein at least one intermediate position value of the vehicle is determined within the time period formed by the time interval between two successive GPS position signals. Furthermore, a control device is proposed for carrying out the method.

### RELATED APPLICATIONS

This application claims the benefit under 35 U.S.C. § 371 as a U.S. National Application of application no. PCT/EP2020/077927, filed on 6 Oct. 2020, which claims the benefit of German Patent Application no. 10 2019 216 104.9, filed 18 Oct. 2019, the contents of which are incorporated herein by reference in their entireties

### FIELD OF THE DISCLOSURE

The present invention relates to a method for processing GPS position signals in a vehicle of the kind defined in more detail in the claims. Furthermore, the invention relates to a control device for carrying out the method.

### BACKGROUND

It is known from the vehicle technology that GPS position signals are received in vehicles within a predefined time interval and are processed in order to control the vehicle. Here, GPS means Global Positioning System and is a global navigation satellite system for positioning.

### SUMMARY

However, it has been found that, depending on the vehicle speed, the time interval of two successively sent GPS position signals causes a level of uncertainty in the control, as changes in the vehicle speed within the time interval are not taken into account, so that incorrect position values are processed, which leads to a false forecast of the speed progression or future driving resistance.

A method for operating a powertrain of a motor vehicle having a drive unit and a transmission is known, for example, from publication DE 10 2010 028 671 A1. The operation of the transmission is controlled by an associated transmission control device, and the operation of the drive unit is controlled by an associated engine control device, wherein GPS data provided by a navigation system automatically triggers shifts in the transmission or automatically provides parameter sets on the basis of which shifts are executed. Due to corresponding inaccuracies or incorrect position data specified by the GPS position signals, the problem arises that the control is also faulty.

The underlying problem of the present invention is to propose a method for processing GPS position signals in a vehicle and a control device for carrying out the method, with which the accuracy and thus the position handling are improved.

According to the invention, this problem is solved by the features of independent claims, wherein advantageous and claimed further developments result from the subclaims and the description as well as the drawings.

Thus, a method for processing GPS position signals in a vehicle is proposed in which the GPS position signals of the vehicle are received successively at a predefined time interval and are processed in order to control the vehicle. In order to improve the accuracy and forecastability of the vehicle position, it is provided that at least one intermediate position value of the vehicle is determined within the time period formed by the time interval between two successive GPS position signals.

The at least one additional intermediate position value results in improved position handling in the vehicle through the optimized GPS forecast. By determining intermediate position values, a virtual rasterization of the time interval is performed by calculating the determined or calculated position values as intermediate values. By calculating an arbitrary number of new position values within the raster, the positioning can be significantly improved.

In this way, the proposed method defines a separate raster in which the intermediate position values are calculated, thereby determining new supporting points in order to optimize the positioning.

Within the scope of the proposed method, it can be provided that each intermediate position value is used as a future vehicle position for forecasting control of the vehicle. The accuracy of the position determination can thus be improved, in order to realize a fuel-optimized shifting strategy in the vehicle.

The intermediate position values to be determined in the method according to the invention can be calculated, for example, from a determined vehicle speed.

It is also conceivable that the position values can be determined by means of transmission speeds, wheel speeds, or also from other sources of sensors, such as an accelerometer.

The number of intermediate position values to be determined also depends on how large the time interval between two received GPS position data signals is selected. For example, with a time interval of 1 second, intermediate position values could occur after 0.33 seconds and after 0.66 seconds. At 0.99 seconds, no calculation of an intermediate position would be performed because a new GPS position signal is expected.

Accordingly, within the scope of the method, it can be provided that a predefined raster is determined for the time interval in order to specify the maximum number of intermediate position values to be determined. For example, it can be provided that, after reaching the predefined number of intermediate position values, the determination of intermediate position values is terminated, in particular when the maximum number of intermediate position values to be determined has been reached.

In the context of a proposed method, it can be provided that the distance traveled by the vehicle is determined on the basis of a last received GPS position signal. The determination of the distance traveled can be specified, for example, by integration of the vehicle speed.

For example, if a GPS position signal is no longer detected due to an error, a so-called TimeOut can be set within the scope of the method. The setting or activation of a TimeOut can take place, for example, when the integrated distance exceeds a threshold. This avoids inaccuracies or errors in the positioning of the vehicle.

It is particularly advantageous in the context of the method that, in the case of a set TimeOut beyond the predefined time interval, the determination of intermediate position values is further carried out in order to realize a continuous extrapolation of the vehicle position.

For example, this can be particularly advantageous in a so-called stop & go driving situation. A TimeOut usually occurs in tunnels, underpasses, or urban canyons because the GPS reception could be disrupted in these situations. By continuously calculating the intermediate position values, the vehicle position can continue to be specified precisely, and thus the availability of the controllable functions can be further increased.

Another aspect of the present invention is to propose a control device for the vehicle that carries out the above-mentioned method.

The present invention is further explained below on the basis of the drawings.

### BRIEF DESCRIPTION OF THE DRAWINGS

The Following are Shown:

FIG. 1: a flowchart of a method according to the invention for processing GPS position signals in a vehicle; and

FIG. 2: a diagram showing vehicle positions specified by GPS position signals and calculated intermediate position values along a forecast horizon.

### DETAILED DESCRIPTION

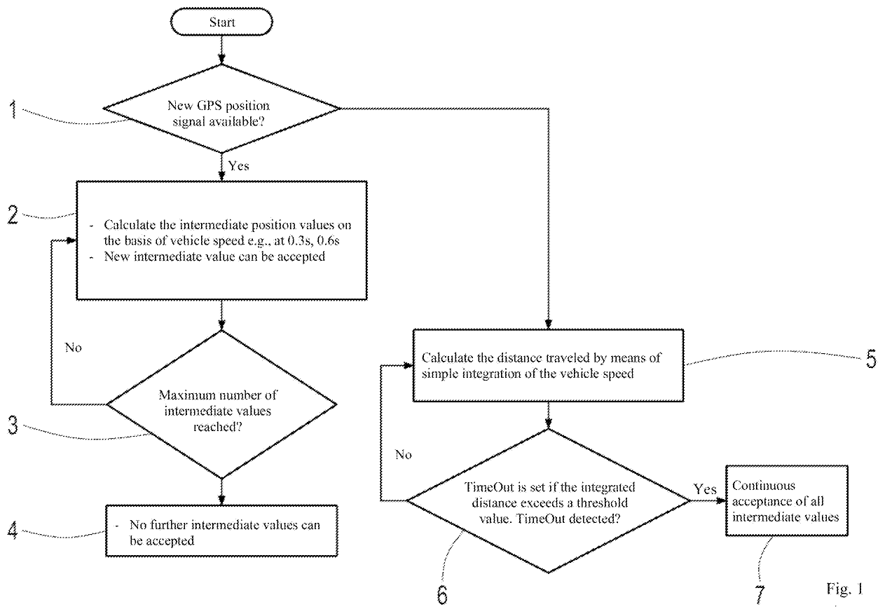

FIG. 1 shows an exemplary flow diagram of a method according to the invention for processing GPS position signals in a vehicle, in particular in a commercial vehicle, for example a truck.

The method begins with the start of the method. Then, in a first method step 1, it is checked whether a new GPS position signal is available. If this is the case, in a second method step 2, intermediate position values are calculated from a vehicle speed, for example after 0.3 seconds, 0.6 seconds, etc. The calculated new intermediate position values are accepted as supporting points for position detection.

In a third method step 3, it is checked whether a maximum number of intermediate position values is reached. If this is not the case, the second method step 2 is repeated, and further intermediate position values are calculated. However, if the maximum number of intermediate position values is reached, it is provided in a fourth method step 4 that no further intermediate values are calculated and accepted.

If no new GPS position signal is available in the first method step 1, the distance traveled by the vehicle is calculated in the context of a fifth method step 5 via simple integration of the vehicle speed.

In a next sixth method step 6, a TimeOut is set when the integrated distance exceeds a threshold. The so-called TimeOut is thus detected. This means that no new GPS position signals are received. Accordingly, in a seventh method step 7, a continuous acceptance of the calculated intermediate position values is provided for the positioning.

If no TimeOut is set, the fifth method step 5 is repeated, in which the distance traveled is calculated by integration of the vehicle speed.

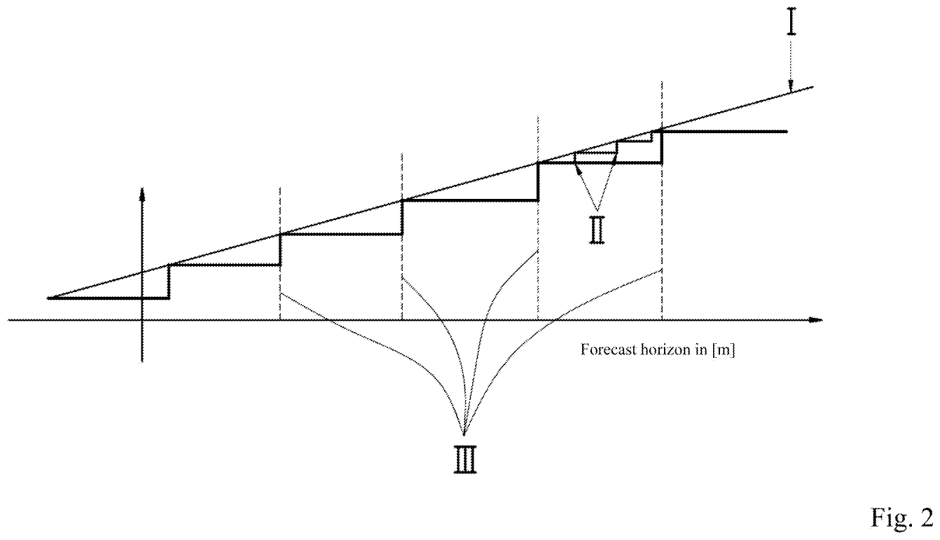

FIG. 2 shows an exemplary diagram of vehicle positions as a forecast horizon in meters, wherein the vehicle position results from the GPS position signals received by dashed lines III.

Further, between two received GPS position signals, additional intermediate position values are calculated, thereby allowing the staircase-shaped profile to be significantly refined, so that the quality of the position determination of the vehicle is significantly improved, which results from the forecast horizon through the two calculated intermediate position values marked with II. Shortly before receiving a new GPS position signal, no further intermediate position value is calculated, so that, in this example, only two intermediate position values result, and the third is no longer calculated. The line profile I shows results from the integration of the speed signal, which is used when the so-called TimeOut is set.

### LIST OF REFERENCE NUMERALS

1—First method step—check whether GPS position signals are available
2—Second method step—calculate intermediate position values
3—Third method step—check whether maximum number of intermediate position values is reached
4—Fourth method step—no further intermediate values are accepted
5—Fifth method step—calculate distance traveled
6—Sixth method step—check whether TimeOut is set
7—Seventh method step—continuously accept intermediate values
I. Position from integration of the speed signal
II. Two self-calculated intermediate position values
III. Dashed line as GPS signal

1-10. (canceled)

11. A method for processing GPS position signals in a vehicle, the method comprising:
receiving GPS position signals of the vehicle successively at a predefined time interval;
processing the GPS position signals in order to control the vehicle; and
determining at least one intermediate position value of the vehicle within a time period formed by the predefined time interval between two successive GPS position signals.

12. The method according to claim 11, comprising:
forecasting control of the vehicle by using each at least one intermediate position value as a future vehicle position.

13. The method according to claim 11, comprising:
determining a vehicle speed; and
calculating the at least one intermediate position value from the determined vehicle speed.

14. The method according to claim 12, comprising:
determining a vehicle speed; and
calculating the at, least one intermediate position value from the determined vehicle speed.

15. The method according to claim 12, comprising:
specifying a predefined raster for the time interval; and
specifying a maximum number of intermediate position, values to be determined based on the predefined raster.

16. The method according to claim 13, comprising:
specifying a predefined raster for the time interval; and
specifying a maximum number of intermediate position values to be determined based on the predefined raster.

17. The method according to claim 16, wherein determining the at least one intermediate position values is terminated after a predefined number of intermediate position values has been reached.

18. The method according to claim 17, comprising:
determining a distance traveled by the vehicle based on a last received GPS position signal.

19. The method according to claim 18, wherein determining the distance traveled is performed by integrating the vehicle speed.

20. The method according to claim 19, comprising:
setting a TimeOut when an integration of the vehicle speed exceeds a threshold value.

21. The method according to claim 20, wherein determining the at least one intermediate position value is carried out beyond a time interval defined by setting the TimeOut.

22. A control device for carrying out the method according to claim 11.

23. A control device for carrying out the method according to claim 21.
